(19) United States
(12) Patent Application Publication
(10) Pub. No.: US 2013/0339268 A1
(43) Pub. Date: Dec. 19, 2013

(54) SYSTEM AND METHOD FOR CREATION AND DISTRIBUTION OF PROPOSALS FOR ACTION

(71) Applicant: The One Page Company LLC, (US)

(72) Inventors: Patrick Riley, San Francisco, CA (US); Joanna Weidenmiller, San Francisco, CA (US); Stefan Proud, Sacramento, CA (US)

(73) Assignee: The One Page Company LLC, San Francisco, CA (US)

(21) Appl. No.: 13/864,446

(22) Filed: Apr. 17, 2013

Related U.S. Application Data
(60) Provisional application No. 61/636,396, filed on Apr. 20, 2012.

(51) Int. Cl. G06Q 10/06; G06Q 10/10

(52) U.S. Cl. CPC G06Q 10/06375; G06Q 10/10
USPC 705/342

(57) ABSTRACT

Techniques and mechanisms described herein facilitate the creation and distribution of proposals for action. According to various embodiments, input information corresponding with each of a plurality of sections to include in a proposal for action may be identified. At least a portion of the input information may be received via a communications interface. Output information to include in the proposal for action may be determined. The output information may be determined at least in part based on the identified input information. A document representing the proposal for action may be created. The created document may include the output information. The created document may be stored on a storage system.

### CROSS-REFERENCE TO RELATED APPLICATIONS

This application claims priority under 35 U.S.C. §119 of prior U.S. Provisional Application No. 61/636,396, filed Apr. 20, 2012, titled “System and Method for Creation & Distribution of Single-Page Documents” by Patrick Riley, which application is herein incorporated by reference in its entirety for all purposes.

### TECHNICAL FIELD

The present disclosure relates to the field of personal and business planning and development, particularly preparing various types of proposals for action.

### DESCRIPTION OF RELATED ART

Business plans and other types of project proposals are vital communication tools in the business world. Companies and individuals must be able to plan potential projects and subsequently communicate these plans in a clear and coherent manner to potential investors and partners. This is often done in the form of a written document outlining and detailing the key elements of the project.

Although clear communication is important, time is also often critical in making business decisions. A proposal or plan may be comprehensive, but too cumbersome and lengthy to read thoroughly. A person may not have time to digest all of the material. Key information can become lost in verbiage and overlooked. As a result, a proposal may be rejected not for failing to be a viable idea, but because it was not communicated efficiently enough.

Likewise, in the job application process, a resume is the standard tool for conveying an applicant's professional qualifications and interests. However, a resume may present a list of such things, yet still fail to express a candidate's real objectives and underlying rationales. Despite a candidate's best efforts to present himself to a prospective employer, his key attributes can be obscured in verbiage and lost upon the reader.

Further, when job hunting, a candidate must organize the search, so as to focus her efforts on the most promising employment leads. Sending out a flurry of resumes to prospective employers may not yield positive results if a candidate is off the mark to begin with. Therefore, taking time to analyze and assess the many factors in employment searching can greatly improve the efficiency of the search.

Establishing a business relationship is often a time-consuming, inefficient, and imprecise process. For instance, employers and job applicants often find it difficult to clearly define and communicate the employment needs of the company and the capabilities and ideas of the job applicant. Such difficulties cause problems such as unnecessary unemployment and suboptimal matches between employer and job applicants. Likewise, both individuals and organizations seeking to engage in relationships such as contracts for procurement or service often find it difficult both to succinctly and plainly describe the needs and abilities of each party and to locate the best business partner for the relationship.

### BRIEF DESCRIPTION OF THE DRAWINGS

The disclosure may best be understood by reference to the following description taken in conjunction with the accompanying drawings, which illustrate particular embodiments.

FIG. 1 illustrates a block diagram of the components a method for summarizing a proposal for action, performed in accordance with one or more embodiments.

FIG. 2 illustrates a block diagram of various operations that may be included in a method to facilitate the creation of a proposal for action, performed in accordance with one or more embodiments.

FIG. 3 illustrates a flow chart comprising various operations that may be included in a method for creating a proposal for action, performed in accordance with one or more embodiments.

FIG. 4 illustrates a flowchart of a method for facilitating interaction between a user and a proposal system, performed in accordance with various embodiments.

FIG. 5 illustrates an organizational diagram of a website user interface, presented in accordance with one or more embodiments.

FIG. 6 illustrates a block diagram of a system configured in accordance with one or more embodiments.

FIG. 7 illustrates a flow chart of a method for generating a proposal for action, performed in accordance with one or more embodiments.

FIGS. 8-13 illustrates examples of portions of a user interface presented in accordance with one or more embodiments.

### DESCRIPTION OF EXAMPLE EMBODIMENTS

Reference will now be made in detail to some specific examples including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of proposals and requests for proposals. However, it should be noted that the techniques of the present invention apply to a wide variety of communications. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Techniques and mechanisms described herein facilitate the creation of proposals for action. The proposals may then be published and viewed by or transmitted to interested recipients. The recipients may then take actions in response to the proposals. A proposal system for facilitating the creation of proposals for action may facilitate various types of business transactions.

According to various embodiments, a proposal system may provide a platform for users to create and publish proposals to fill open positions, perform tasks, or complete projects. For instance, the proposal system may provide a platform for job seekers to create and submit proposals or ideas for open job positions. The proposal system may facilitate the gathering of statistics and analytics, such as information related to employment or company performance. The proposal system may facilitate the development of new techniques for matching business partners with each other, employees with employers, and problems with solutions.

### Example Embodiments

According to various embodiments, a proposal may be a description of how the author suggests solving a problem, filling an open job position, completing a task, or accomplishing any other objective. The proposal may specify one or more goals, discuss why action is necessary, describe financial considerations, identify a current state of affairs, and/or propose one or more actions to take.

According to various embodiments, a proposal may include designated content sections, which may appear in a designated order. For example, a proposal may include Title and/or Subtitle sections that define the proposal, Target and/or Secondary Target sections that identify the goals of the proposal, a Rationale section that lays out the basic reasons why the action is necessary, a Financial section that describes the financial aspects of the deal, a Status section that describes a current state of affairs, and/or an Action section that indicates exactly what the proposer wants the recipient to do.

According to various embodiments, a proposal may be generated in response to a request for proposal (RFP) issued on behalf of an entity. The RFP may describe the needs and challenges surrounding a task, problem, or open employment position associated with the entity. In particular embodiments, the RFP may be created independently or in conjunction with the proposal system.

According to various embodiments, a proposal system may provide assistance to a user creating a proposal or RFP. For example, the proposal system may suggest content for including in the proposal. As another example, the proposal system may assist the user with formatting the proposal. As yet another example, the proposal system may help the user elicit reviews of the proposal by other individuals. As still another example, the proposal system may facilitate the publication of the proposal or the transmission of the proposal to recipients. By guiding the user in a process to create a proposal, the proposal system may help ensure that the proposal more accurately describes the skills, intentions, and plans of the entity creating the proposal.

According to various embodiments, authoring and submitting a proposal for employment may offer various advantages to job applicants in comparison with sending a traditional resume. For example, a proposal may allow a job applicant to present a compelling case for a company to hire the applicant. The proposal may be used to show the prospective employer exactly how the applicant will make the company better and more successful. By presenting the applicant in a way that an ordinary resume can't accomplish, a proposal may significantly increase the applicant's chances of landing a job. Creating a proposal may also help give the applicant helpful insights into the applicant's unique personal qualities and life experiences, which may help the applicant better stand out as a job candidate.

According to various embodiments, receiving proposals for employment may offer various advantages to organizations in comparison with traditional postings on job boards or other mechanisms and techniques to alerting prospective job applicants to employment opportunities. Traditional recruitment typically involves resumes. While resumes often provide information regarding personal data and a candidate's experience and knowledge, resumes typically provide little detail regarding the candidate's mindset and attitude. In contrast to resumes, proposals created in accordance with the techniques described herein may be used to evaluate a candidate's abilities in comprehension, analysis, synthesis, and evaluation. In order to solicit proposals, a company may create a request for proposals that describe the challenges and needs facing the organization. Then, the company will receive a proposal from each job applicant that describes exactly how that job applicant plans to solve the challenges and fulfill the needs of the company, for instance as described in an RFP.

In some cases, the discussion of embodiments herein refers to proposals and RFPs authored and processed for the purposes of connecting job applicants with potential employers. However, according to various embodiments, the techniques and mechanisms discussed herein may be used to facilitate a wide variety of business transactions and relationships. These transactions and relationships may include, but are not limited to, employment opportunities, procurement contracts, service agreements, consulting arrangements, and legal representation.

According to various embodiments, a proposal and/or an RFP may be created in accordance with a designated format. In particular embodiments, the format may limit both each proposal and each RFP to a single page. Accordingly, some embodiments discussed herein and illustrated in the drawings may refer to a one page proposal. However, various types of formats and restrictions on proposals and RFPs may be used. For example, proposals and/or RFPs may be limited to a different length. As another example, proposals and/or RFPs may be created in accordance with restrictions on the type and order of content included in each document. As yet another example, in some embodiments formatting characteristics such as content or length may server as guidelines rather than strict limits. In some embodiments, the types of formats and restrictions used may be strategically determined based on factors such as the type of information conveyed by the communications and the type of industry in which the communications are conducted.

According to various embodiments, the infrastructure for providing a proposal system may be configured in various ways. In particular embodiments, the infrastructure may be provided via a cloud computing framework. In a cloud computing framework, hardware and basic software such as web server software may be provided in a scalable, on-demand fashion by a third-party, while the service provider of the proposal system provides the application logic and other high-level functionality for generating the proposal system. Alternately, the infrastructure may be provided via a more conventional computing framework, for example a computing framework in which the hardware and/or basic software for providing access to the system is controlled by the service provider of the proposal system.

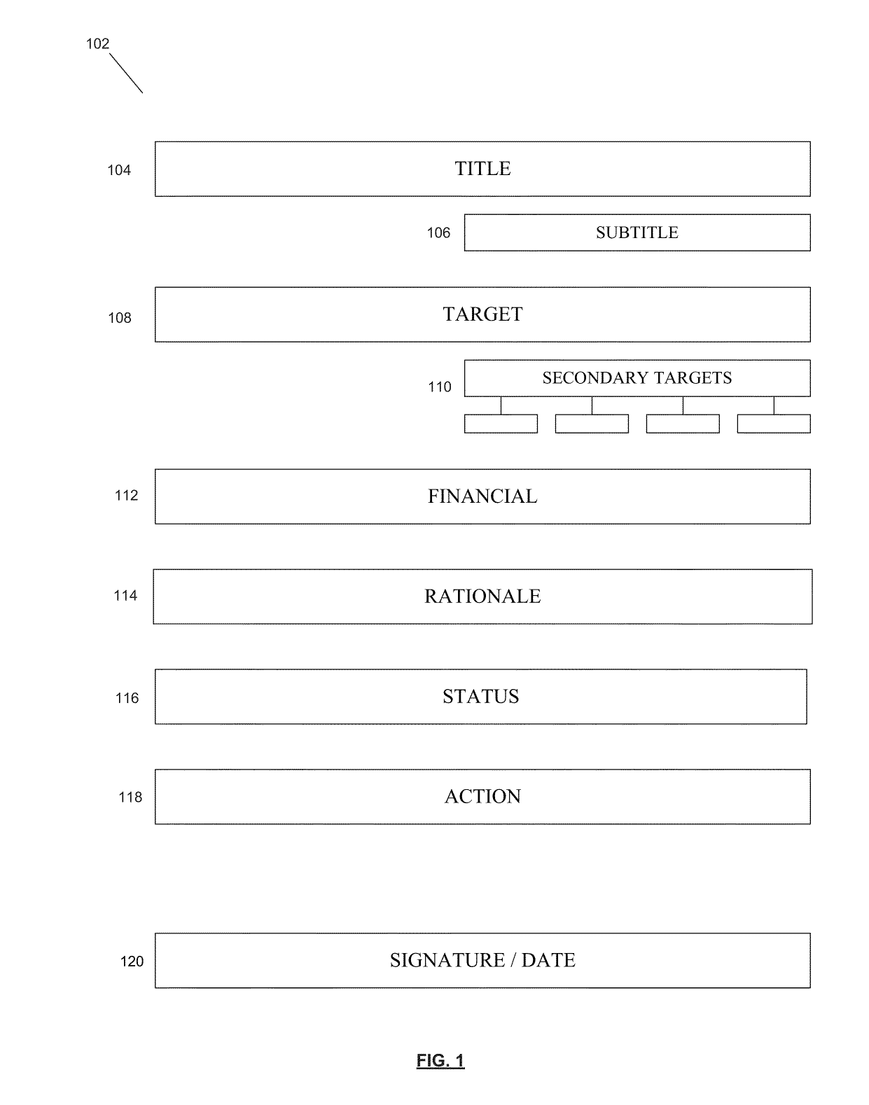

FIG. 1 illustrates a block diagram of the components a method for summarizing a proposal for action 102, performed in accordance with one or more embodiments. A proposal for action 102 can be a proposal, such as, but not limited to, a project proposal or business plan, a job application or solicitation, or any other suitable item. In some embodiments, a proposal for action may be a “One-Page Job Proposal” that describes how an individual can fill an employment role for an entity.

According to various embodiments, a method may include one or more of the following operations. A title 104 can be created to encapsulate the content of an entire proposal for action 102. A subtitle 106 can be created to connect to a title 104 and provide further information regarding the content. A target 108 can be created to include a “target statement” that can express a goal of the proposal for action 102. At least one secondary target 110 can be created to summarize secondary objectives of the proposal for action 102 that can support a target 108. A financial component 112 can be created to quantify and qualify the financial aspects of a proposal for action 102. A rationale 114 can be created to explain the validity, desirability, and feasibility of a target 108 and secondary targets 110. A status component 116 can be created to explain the current situation for a proposal for action 102, and can be updated as needed. An action component 118 can be created to express a request for what is presently needed to commence putting a proposal into action. A date and signature component 120 can be created to provide verification and indicate ownership and authorship of a proposal for action 102.

In some embodiments, a proposal for action may include a rationale or “choice” section. The rationale section may be used to describe the reasoning behind a particular proposal. For example, a rationale section may be used to describe why a user selected a particular company, industry, or target individual at a company.

In some embodiments, the components of a proposal for action 102 can be arranged in the top-to-bottom order as shown in FIG. 1, but in other embodiments can be arranged in any other suitable manner. Further, other embodiments can include additional components and/or subcomponents, or fewer components.

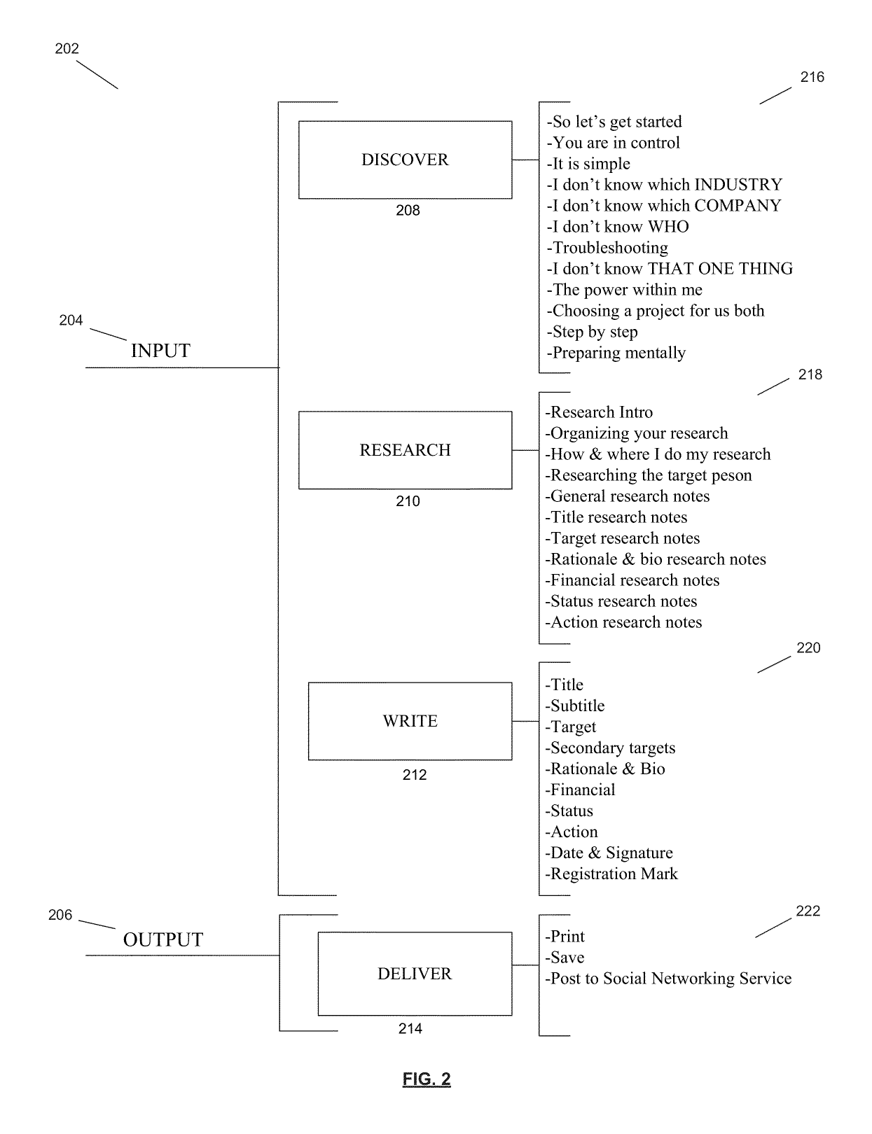

FIG. 2 illustrates a block diagram of various operations that may be included in a method to facilitate the creation of a proposal for action, performed in accordance with one or more embodiments. As shown in FIG. 2, the system may allow a user to input, organize, and analyze personal information, which can then be processed and used to produce a proposal for action 102. In some embodiments, the operations can be logically divided into an input portion 204 and an output portion 206.

In some implementations, input 204 can be divided into three stages: “discover” 208, “research” 210, and “write” 212. However, in other embodiments, the input portion 204 can be divided into any other suitable number of stages, which can include all or part of the operations discover 208, research 210, and write 212.

In some embodiments, the sole stage for the output 206 may be the “deliver” stage 214. Alternately, some embodiments may include other stages in addition to, or instead of, the deliver stage 214. For instance, the output stage may include operations such as publish (e.g., to a job board) or transmit (e.g., to a proposal recipient).

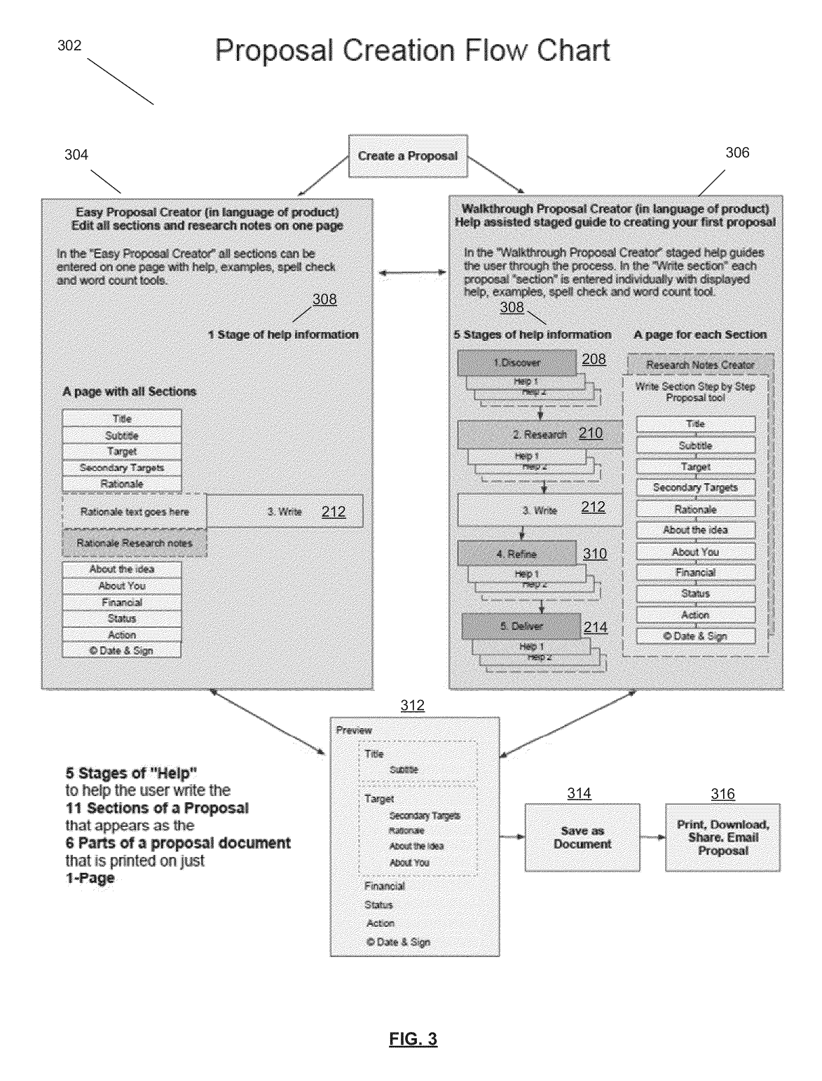

FIG. 3 illustrates a flow chart comprising various operations that may be included in a method for creating a proposal for action, performed in accordance with one or more embodiments. In some implementations, as shown in FIG. 3, a method 302 to create a proposal for action 102 can include more than one proposal-creation technique, such as the first proposal creation option 304 and the second proposal-creation option 306.

In some embodiments, a first proposal-creation option 304 can be a “simplified” proposal creator (e.g., “Easy Proposal Creator”), which can have a user interface with all input sections presented in a simple interface (e.g., on one page). As shown in FIG. 3, a first proposal-creation option 304 can include a write 212 stage, in which a user can input information for components of a method for summarizing a proposal for action 102. The information received may be used to generation one or more of the following components: title 104, subtitle 106, target 108, secondary target(s) 110, financial 112, rationale 113, status 116, action 118, and signature and date 120.

In some implementations, a simplified proposal creator may be limited to a write stage. For instance, presenting a simplified user interface may facilitate the expeditious creation of a proposal for action, particularly for users who know the details of the proposal that they would like to create or for users who may be overwhelmed by a more complicated interface. In other implementations, a simplified proposal creator may include additional options, such as any of those discussed with respect to the second proposal option 306.

In some embodiments, as shown in FIG. 3, a user interface for a first proposal-creation option 304 can be a single web page with input fields for information for components of a method for summarizing a proposal for action 102. For instance, a user interface can present help information 308 that can correspond to a write stage 212. However, in other embodiments a user proposal creation option can include potentially many different web pages, for instance each with a corresponding help page.

In some embodiments, a second proposal-creation option 306 can be a more “detailed” proposal creator (e.g., “Walkthrough Proposal Creator”), which can have a user interface with different stages (e.g., discover 208, research 210, write 212, refine 310, and deliver 214). Some or all of these stages may be presented on one or more separate, individual pages. As shown in FIG. 3, a second proposal-creation option 306 can comprise multiple stages, in which a user can input and organize information that can develop into components of a method for summarizing a proposal for action 102: title 104, subtitle 106, target 108, secondary target(s) 110, financial 112, rationale 113, status 116, action 118, and signature and date 120.

For example, the financial information may include a user's financial goals or other finance-related information. As another example, the input status information may detail time commitments or other status information involved in the proposal. As yet another example, one or more actions that the user is proposing that the recipient of the proposal take may be described in the action component of the proposal.

In some embodiments, as shown in FIG. 3, a user interface for a second proposal-creation option 306 can include multiple web pages, each with input fields for information. In some embodiments, a user interface can present help information 308 that can correspond to each stage. However, other embodiments can have a user interface with multiple stages and corresponding stages of help information.

In conjunction with information provided via either a first proposal-creation option 304 or a second proposal-creation option 306, a method 302 can create a preview 312 of a proposal. In the preview, a user can review the created one-page proposal for action 102. If a user is satisfied, the proposal for action 102 can be saved as a document 314, which can be in Microsoft Word, PDF, text, HTML, or any other suitable format. A user can then share 316 a document 314 via printing, downloading, emailing, or any other suitable method.

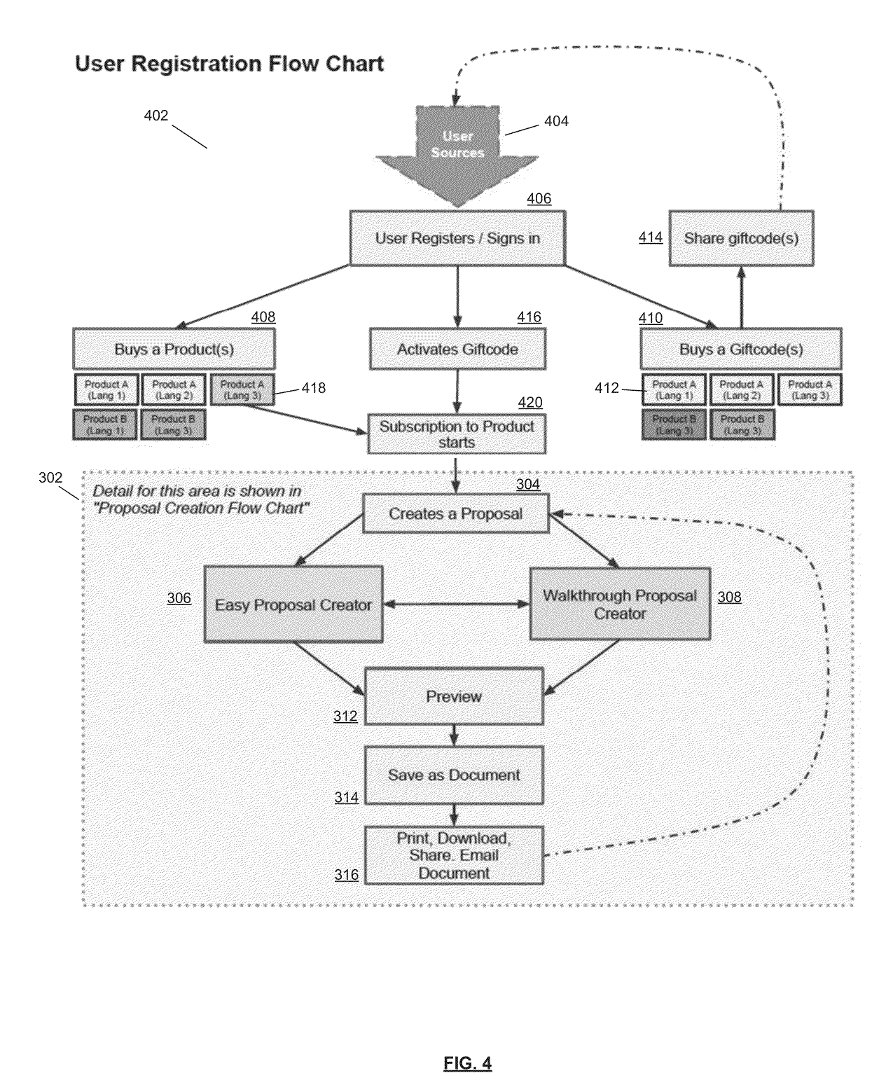

FIG. 4 illustrates a flowchart 402 of a method for facilitating interaction between a user and a proposal system, performed in accordance with various embodiments. A user can source 404 a system for creating a Proposal for Action. A user can sign in to and/or register with the proposal system. Once signed in 406, a user may be presented with various options, such as the ability to purchase a product 408 provided by the proposal system, activate a giftcode 416, or purchase a giftcode 410 for use in conjunction with the proposal system.

According to various embodiments, in purchasing a giftcode 410, a user can select from one or more product 412. A user can share a purchased giftcode 414 with another user, who can register and sign in 406. Alternatively, a user can use a purchased giftcode 414 at a later time to acquire access to a product.

According to various embodiments, after registering and/or signing in 406, a user can access products by either activating a giftcode 416 for a product previously selected by the purchaser of a giftcode or directly buying a product 408. If directly buying a product 408, a user can select from one or more product 418. Once a giftcode is activated 416 or a product purchased 408, a subscription to a given product starts 420, and a user can access proposal-creating software 302.

According to various embodiments, each product may represent a service or set of services provided via the proposal system. For example, a product may allow a user access to the proposal system to create proposals for a designated period of time. As another example, a product may allow a user access to the proposal system to create a designated number or type of proposals. As yet another example, a product may be linked with a particular language. As still another example, different products may provide access to different proposal creation procedures.

According to various embodiments, in creating a proposal 304, as shown in the embodiment depicted in FIG. 4, a user can choose between an “Easy Proposal Creator” 306 and a “Walkthrough Proposal Creator” 308. Further, in some embodiments, a user can switch between each of the proposal-creator options while in the proposal-creation process. In some implementations, the proposal system may include various types of proposal creation techniques for use by users.

According to various embodiments, when a user has entered the desired information and a Proposal for Action 102 has been created, a user can preview 312 the proposal. If further drafting and editing is needed, a user can return to the desired proposal-creator options, and then again preview 312 a Proposal for Action 102. When satisfied that a Proposal for Action 102 is finished, a user can save a proposal as a document 314, and then print, download, share, email, and distribute a proposal 316 by any other suitable method.

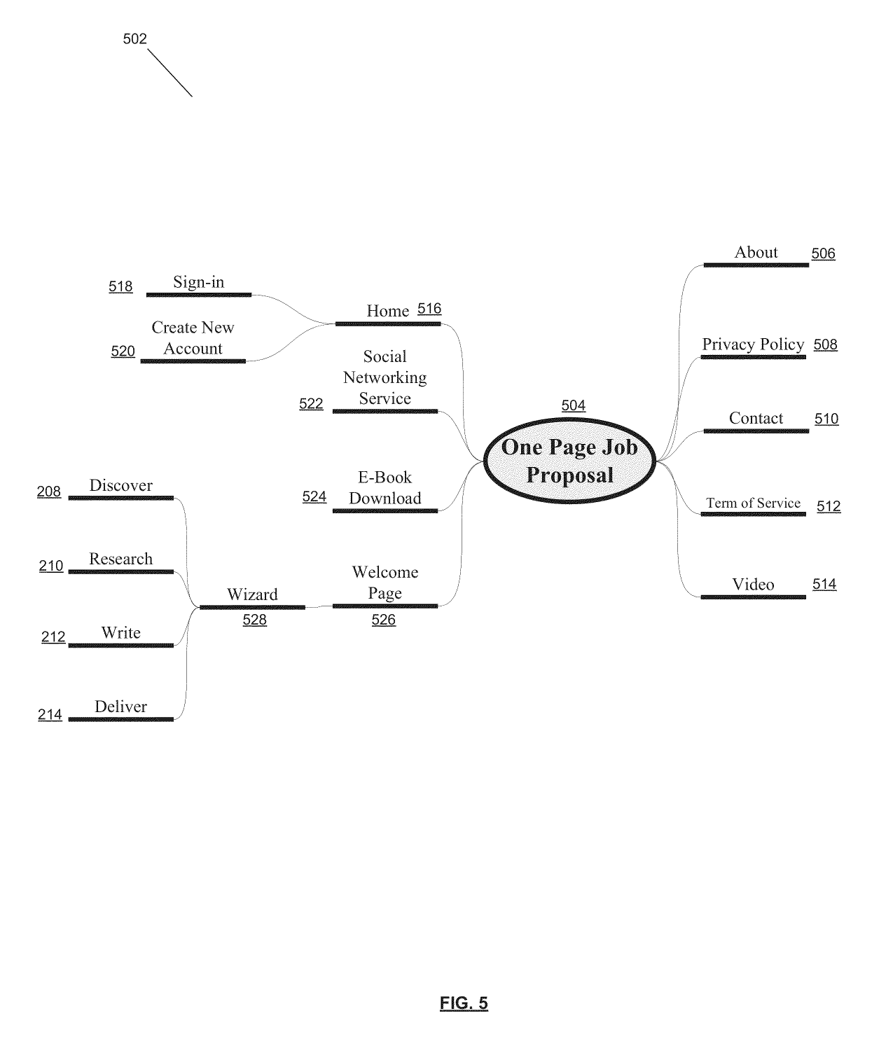

FIG. 5 illustrates an organizational diagram of a website user interface 502, presented in accordance with one or more embodiments. In some embodiments, a method for creating a proposal for action 102 may be used in conjunction with employment-seeking activities. Such embodiments can include one or more of a “One-Page Job Proposal” wizard, a downloadable eBook, and membership in a social networking service. Some or all of these components may be included in a website user interface 502.

As shown in FIG. 5, central to a website user interface 502 can be a proposal for action 102, which can be a “One-Page Job Proposal” 504. A website user interface 502 can have informational pages comprising an About page 506, a Privacy Policy page 508, a Contact page 510, a Terms of Service page 512, as well as any other suitable pages. A website user interface 502 can further comprise a video 514. For instance, one or more explanatory videos may describe to a user how to use the website or proposal creation wizard.

As shown in FIG. 5, a website user interface 502 can have a home page 516. The home page may contain links to the previously discussed informational pages. The home page may also include a sign-in portal 518 for returning users and “Create New Account” link 520 for new users.

In some embodiments, a website user interface 502 can have links to supplemental services, such as, but not limited to a social networking service 522, an e-book download 524, and proposal-related search engines. According to various embodiments, users may access a welcome page 526 for proposal creation software 202, which can comprise a “wizard” 528. Here, a user can work through the stages (e.g., discover 208, research 210, write 212, and deliver 214) to create a proposal for action 102, which can be a “One-Page Job Proposal.”

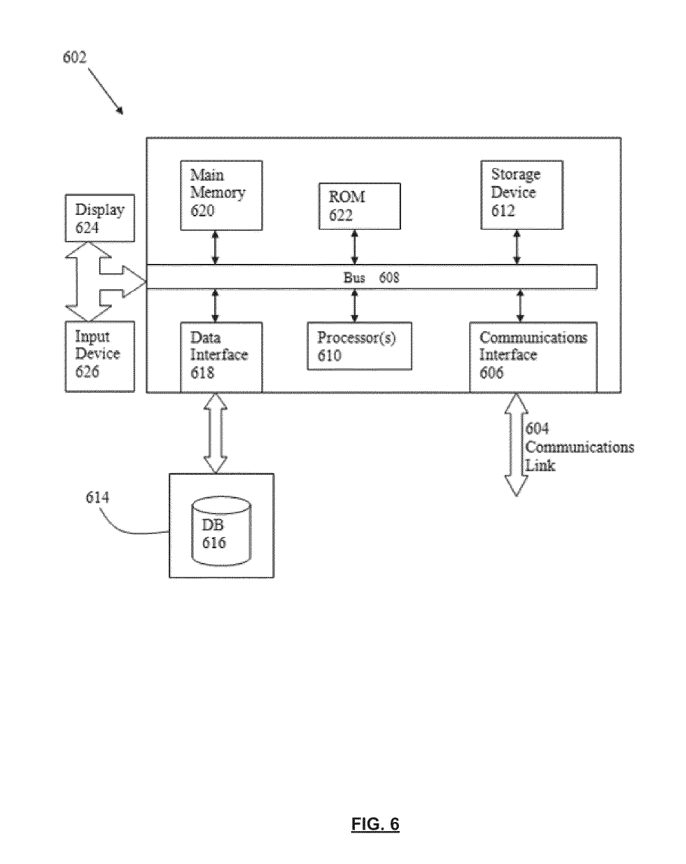

The execution of the sequences of instructions required to practice techniques described herein may in some instances be performed at least in part by a computer system 602 as shown in FIG. 6. In some embodiments, execution of the sequences of instructions can be performed by a single computer system 602. According to other embodiments, two or more computer systems 602 coupled by a communication link 604 can perform the sequence of instructions in coordination with one another. Although a description of only one computer system 602 will be presented below, it should be understood that any number of computer systems can be employed to practice the embodiments.

A computer system 602 according to an embodiment will now be described with reference to FIG. 6, which illustrates a block diagram of the functional components of a computer system 602. As used herein, the term “computer system” 602 is broadly used to describe any computing device that can store and independently run one or more programs.

Each computer system 602 can include a communication interface 606 that can be coupled to a bus 608. A communication interface 606 can provide two-way communication between computer systems 602. A communication interface 606 of a respective computer system 602 can transmit and receive electrical, electromagnetic, or optical signals that can include data streams representing various types of signal information, such as, but not limited to, instructions, messages and data. A communication link 604 can link one computer system 602 with another computer system 602. A communication link 604 can be a LAN, in which case the communication interface 606 can be a LAN card, or a communication link 604 can be a PSTN, in which case a communication interface 606 can be an integrated services digital network (ISDN) card or a modem, or a communication link 604 can be the Internet, in which case a communication interface 606 can be a dial-up, cable or wireless modem. In various embodiments, a communication link 604 can be any other suitable device.

A computer system 602 can transmit and receive messages, data, and instructions, including programs (e.g., application code), through its respective communication link 604 and communication interface 606. Received program code can be executed by the respective processor(s) 610 as it is received. Alternately, or additionally, received program code can be stored in the storage device 612 or other associated non-volatile media for later execution.

In some embodiments, a computer system 602 can operate in conjunction with a data storage system 614. For example, a data storage system 614 can contain a database 616 that can be readily accessible by the computer system 602. A computer system 602 can communicate with a data storage system 614 through a data interface 618. A data interface 618, which can be coupled to a bus 608, can transmit and receive electrical, electromagnetic or optical signals that can include, but are not limited to data streams representing various types of signal information such as instructions, messages, and data. In some embodiments, the functions of a data interface 618 can be performed by a communications interface 606.

Computer system 602 can include a bus 608 or other communication mechanism for communicating instructions, messages, and other data. The computer system 602 may also include one or more processors 610 for processing information. The one or more processors 610 may be coupled with the bus 608. Computer system 602 can also include a main memory 620, such as a random access memory (RAM) or other dynamic storage device for storing dynamic data and instructions to be executed by processor(s) 610. The main memory 620 may also be coupled to the bus 608. Main memory 620 also can be used for storing temporary data (e.g., variables), or other intermediate information during execution of instructions by processor(s) 610.

A computer system 602 can further include a read only memory (ROM) 622 or other static storage device coupled to the bus 608 for storing static data and instructions for the processor(s) 610. A storage device 612 can also be provided and coupled to a bus 608 for storing data and instructions for processor(s) 610. The types of storage devices that may be used may include, but are not limited to, one or more optical disks, magnetic disks, or other storage systems.

A computer system 602 can be coupled via a bus 608 to a display device 624, such as, but not limited to, a cathode ray tube (CRT), liquid crystal display (LCD), or any other suitable device for displaying information to a user. An input device 626 can be coupled to a bus 608 for communicating information and command selections to processor(s) 610. The input device 626 may include, for instance, a mouse and/or a keyboard.

According to some embodiments, an individual computer system 602 can perform specific operations by its respective processor(s) 610 executing one or more sequences of one or more instructions contained in the main memory 620. Such instructions can be read into the main memory 620 from another computer-usable medium, such as a ROM 622 or a storage device 612. Execution of the sequences of instructions contained in the main memory 620 can cause processor(s) 610 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 610. Such a medium can take many forms, including, but not limited to, non-volatile and volatile media. Non-volatile media that can retain information in the absence of power may include the ROM 622, CD ROM, magnetic tape, magnetic discs, and any other suitable devices. Volatile media that cannot retain information in the absence of power may include, for instance, main memory 620.

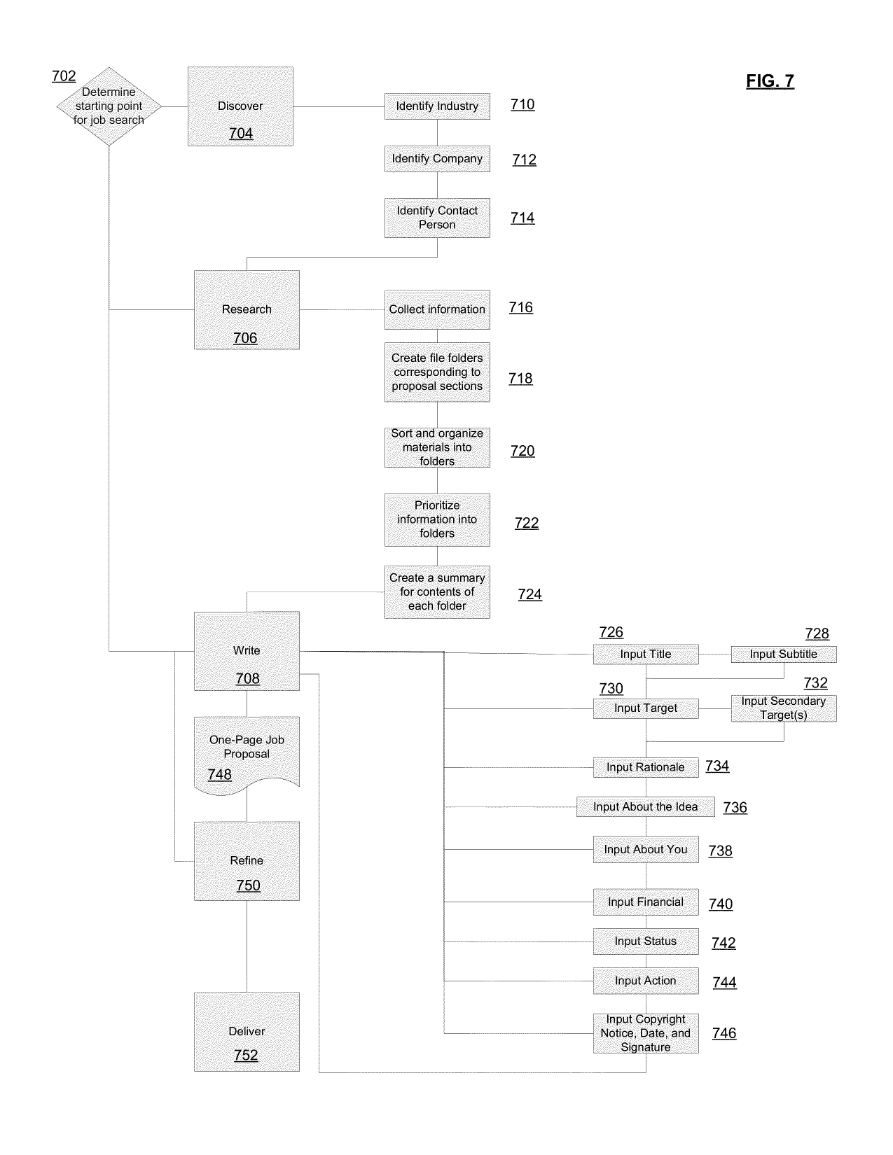

FIG. 7 illustrates a flow chart of a method for generating a proposal for action, performed in accordance with one or more embodiments. In some embodiments, as shown in FIG. 7, techniques for creating a proposal for action may include various operations. A user conducting an employment search or another type of proposal creation process can decide at which point he wishes to enter the process 702, depending on what efforts he has put forth prior to beginning to use the present system. For example, a user may enter the process at a discover 704 stage, a research 706 stage, a write 708 stage, or at any other stage.

According to various embodiments, a user entering the system at the discover stage 704 can proceed to work through a series of narrowing-down operations. For instance, an industry of interest 710 may be determined based on pre-determined interest or by conducting research via Standard Industrial Classification (SIC) codes, Electronic Data Gathering, Analysis, and Retrieval (EDGAR), the Securities and Exchange Commission (SEC), or any other suitable database. Alternately, or additionally, a specific company of interest 712 may be identified using the previously described resources. A user can also identify a contact person 714 within a selected company to whom to send a resulting proposal for action such as a one-page job proposal.

According to various embodiments, identifying a job and/or industry associated with the job proposal may be performed at least in part by presenting a custom user interface. For example, the custom interface may be used to receive answers to a structured series of questions. These answers may be converted into database queries that may be used to retrieve information from a database of jobs and industries. Alternately, or additionally, the answers may be converted into search queries that may be used to retrieve information regarding jobs and industries from a search engine. In conjunction with such processes, a user may determine which industry or industries he wishes to work in and may identify job opportunities within a selected industry.

According to various embodiments, API integration with third party online databases, social networks, and search engines may be used to identify individuals in the users who might be helpful. For instance, individuals who currently work or previously worked in the user's desired company or industry may be identified. The individuals may be identified from the user's existing social network or from another location. These individuals can be contacted through the application with electronic messages, via e-mail, and/or hard copy mail for help in gaining access to more information.

According to various embodiments, users may be able to save the details of potentially useful companies or individuals. For instance, information may be saved in a “notes” tool for use in the “write” stage. The contact information may be utilized in the “deliver” stage to allow the user to share a proposal with the “connected” contacts.

According to various embodiments, a user may conduct research on the identified industry, company, and/or contact person in a research stage 706. Research 706 can include any or all of the following operations. Information can be collected 716 from the user or from another information source. One or more file folders or categories 718 can be created. For instance, a file folder or category may correspond to a section of a proposal as shown in FIG. 3. Collected information can be sorted and organized 720 into these folders or categories. Information in these folders can be prioritized 722 or summarized 724.

According to various embodiments, research may be conducted in conjunction with a “notes” storing tool. The notes tool may aggregate notes or information collected during the research process. The notes may then be displayed in the proposal writing tool.

According to various embodiments, notes may be created in various ways. For example, notes may be created by receiving text typed into the interface, receiving links (e.g., URL's) or data from websites, or by receiving information via API integration with third party online databases, search engines, or social networks. As another example, notes may be created based on answers received in response to one or more structured questions. Questions may be structured to allow answers to be aggregated and “compiled” (e.g., re-formatted) to create basic content for the “write” stage.

In some implementations, the proposal system may include API integration with third party online databases, social networks, and online search engines. By providing such integration, the system may automatically locate or help a user locate information about the desired company and individuals in that company. The system may then save the details of useful companies or individuals into the “notes” tool for use in the “write” stage or in other stages of proposal creation.

A user can now write a proposal for action, such as a one-page job proposal in the write stage 708. Writing 708 may include identifying information for each section of a proposal. Information may be identified based on user input a user can input title information 726. A user can input subtitle information 728, or proceed directly to inputting target information 730. A user can either input information for one or more secondary targets 732 or proceed directly to inputting rationale information 734. A user can input information about the idea 736 and input about the user 738. A user can provide financial information 740, status information 742, action information 744, copyright information, signature information, and date information 746.

According to various embodiments, in the write stage a user may type or dictate all or portions of the proposal into an interface such as an interface in a webpage or a native application. For instance, the interface may include different sections associated with different portions of the proposal for action. Although the write 708 steps are described in FIG. 7 has being presented in a particular order, the interface may facilitate the receipt of user input in various orders.

According to various embodiments, the proposal system may use information received from the user to generation the proposal for action. For example, the proposal system may place information received from the user directly into the proposal for action. As another example, the proposal system may use information received from the user to identify information to place into the proposal. For instance, the proposal system may use information received from the user to generate a proper copyright notice or company name based on a template or search query.

In some implementations, the interface may provide assistance such as examples of proposals or proposal sections, help and guidance with writing each section through text, video and audio content, word count information, grammatical assistance, spell checking, and/or previewing tools for improving the content of the proposal. This tool may be interlinked with other tools, such as the “notes” tool, to allow users to easily view the notes and other information that they have collected. In some instances, “compiled” information may be presented directly in the content writing box for editing.

In some embodiments, software can use the inputted information to create a proposal for action 748. A user can then refine the proposal at the refine stage 750 by reviewing and editing the document. If needed a user can return to the write stage 708 and edit previous inputs.

According to various embodiments, Users will be able to share proposals for review with third parties (e.g., paid or unpaid) via electronic messages with attached electronic documents and/or hard copy mail. Third parties, such as professional contacts or target companies, may provide feedback and notes. This feedback can be entered manually or automatically into an online interface that stores these notes and allows the author and the reviewer (or reviewers) to respond to suggestions and queries. For example, the suggestions and recommendation may be shown in the format of a series of “notes in the margin”. Each piece of feedback can be then be related to content in the proposal in a directly visual way.

According to various embodiments, if a user is satisfied with the created proposal for action 748, a user can deliver 752 the document via email, social networking, postal mail, or any other suitable method. A document may be presented in PDF, Microsoft Word, HTML, text, or any other suitable format.

According to various embodiments, proposals can be shared with social networks through “apps” (e.g., software programs designed to deliver content). These apps may facilitate the sharing and viewing of proposals. For example, an API may be provided to facilitate integration with third party online databases and social networks. In this way, a user may share a proposal through these social networks via electronic messages and/or hard copy mail.

According to various embodiments, the user interface for facilitating the creation of a proposal for action may include any or all of a variety of components. Each component may be located on its own screen, or different components may share a screen. As a first example, in a discover stage, one component may explain how the application works. As a second example, a component may give advice for determining the type of company and/or person the applicant wants to work for. As a third example, a component may explain the importance of investing time and adequate preparation into creating a one-page job proposal. As a fourth example, a component may explain the structure of a one-page job proposal.

According to various embodiments, a user interface component may facilitate the identification of an industry, for instance as discussed with respect to operation 710. Various categories and subcategories may be provided to assist a user in identifying the appropriate industry applicable to his or her one-page proposal.

According to various embodiments, an identify company stage of the proposal creation process may include one or more user interface components, for instance as discussed with respect to operation 712. In a first example, a user interface component may facilitate the identification of a contact person, as discussed with respect to operation 714. In a second example, a user interface component may assist a user when he or she feels discouraged and/or stuck in the job hunt process. In a third example, a user interface component may help a user pinpoint his or her strengths as they relate to the job process. In a fourth example, a user interface component may user discover their passions as they relate to prospective jobs. In a fifth example, a user interface component may illustrate a step that enables a user to identify a specific idea that can attract potential employers.

According to various embodiments, a research stage of the proposal creation process may include one or more user interface components, for instance as discussed with respect to operation 706. In a first example, a user interface component may help to organize research during the job process by creating and using file folders as discussed with respect to operations 718-722. In a second example, a user interface component may describe how to prepare research notes and create a summary for contents of each folder, as discussed with respect to operation 724. As a third example, a user interface component may assist a user with locating appropriate information pertaining to the process, as discussed with respect to operation 716. As a fourth example, a user interface component may help to find the intended recipient of a user's proposal.

According to various embodiments, a write stage of the proposal creation process may include one or more user interface components, as discussed with respect to operation 212. These user interface components may facilitate the receipt and processing of information for writing the proposal, such as the information included in the proposal or data used to generate the information included in the proposal.

According to various embodiments, a deliver stage of the proposal creation process may include one or more user interface components, as discussed with respect to operation 752. In a first example, a user interface component may allow a user to be given guidance about how to ensure that his or her job proposal gets into the right hands. In a second example, a user interface component may explain the process of bypassing a human resources department and contacting prospective employers directly. For instance, a user can be taught how to avoid middlemen in the job search process and encouraged to submit his or her proposal. In a third example, a user interface component may provide the user with additional advice. In a fourth example, a user interface component may present contact/support information.

According to various embodiments, a refine stage of the proposal creation process may include one or more user interface components, as discussed with respect to operation 750. In one example, a user interface component may describe how to whittle down a job proposal draft. In a second example, a user interface component may be used for learning how to edit wording and conduct grammar checks, while formatting and hard copy production can be explained. In a third example, an example of a one-page proposal for action can be shown and described.

According to various embodiments, a research notes stage of the proposal creation process may allow a user to store notes pertaining to important sections of the one-page job proposal process.

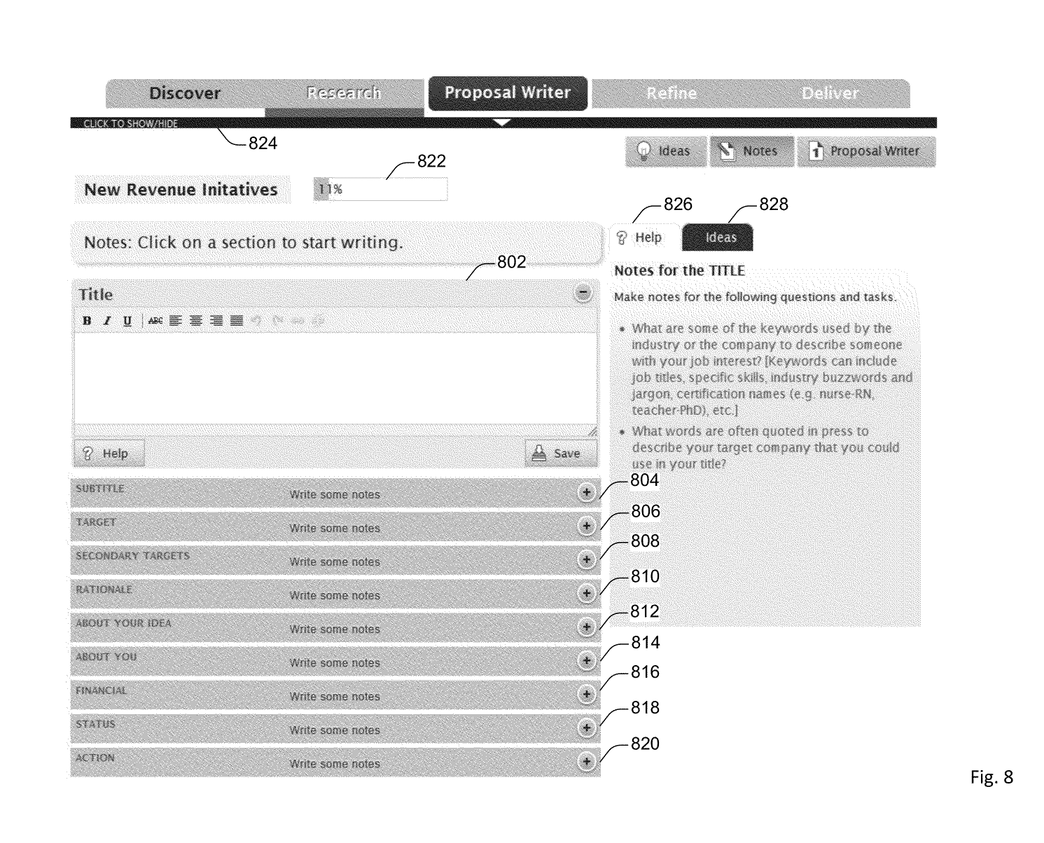

FIG. 8 shows an example of a user interface, presented in accordance with one or more embodiments. The user interface shown in FIG. 8 includes components for providing information used to generate various portions of a proposal for action. For instance, the user interface shown in FIG. 8 includes a title component 802, a subtitle component 804, a target component 806, a secondary target component 808, a rationale component 810, an idea component 812, an about you component 816, a financial component 816, a status component 818, and an action component 820.

According to various embodiments, the user interface shown in FIG. 8 may be presented in conjunction with a write stage associated with proposal generation. During the write stage, the user may use the user interface to provide various types of input information for using in conjunction with the proposal. For instance, the user may specify the content of one or more of the proposal portions.

According to various embodiments, as shown with respect to the title component 802, a user may provide information in a text box. Each user interface component may be expanded or hidden to facilitate ease of navigation through the proposal writing process. In some instances, the information provided in the user interface component may be included directly in the proposal.

According to various embodiments, information provided in a user interface component may be used to determine information to include in the proposal. For example, information may be used in a database or search query to identify relevant information stored in a database system or accessible via a search engine.

The user interface shown in FIG. 8 also includes a completion component 822. According to various embodiments, the completion component may be used to provide visual feedback to a user about the user's progress through the proposal creation process. In FIG. 8, the user has finished 11% of the proposal creation process.

The user interface shown in FIG. 8 includes a drop-down help component 824. According to various embodiments, when selected, the drop-down help component 824 may provide supporting and explanatory information such as information sources for different components. For instance, the drop-down help component 824 may present an interactive research tool allowing a user to provide input for locating information to include in the proposal. The user could, for example, provide information that could be used to identify targets for a proposal such as individuals in the user's social network, industries in which the user's skills might apply, or companies within a given industry.

The user interface shown in FIG. 8 includes the help tab 826. According to various embodiments, when selected, the help tab 826 may present information such as tips regarding the content to include in different sections of a proposal. For instance, in FIG. 8, the help tab suggests that the title should include keywords used by the industry or the company to describe a job interest. The help tab also recommends including words that are often quoted in the press to describe the company targeted by the job proposal.

The user interface shown in FIG. 8 includes an ideas tab 826. According to various embodiments, when selected, the ideas tab 828 may allow the user to record thoughts and notes regarding one or more proposal sections. For instance, the user might record alternate titles, URL's to links related to a rationale, or information describing a target company, individual, or industry.

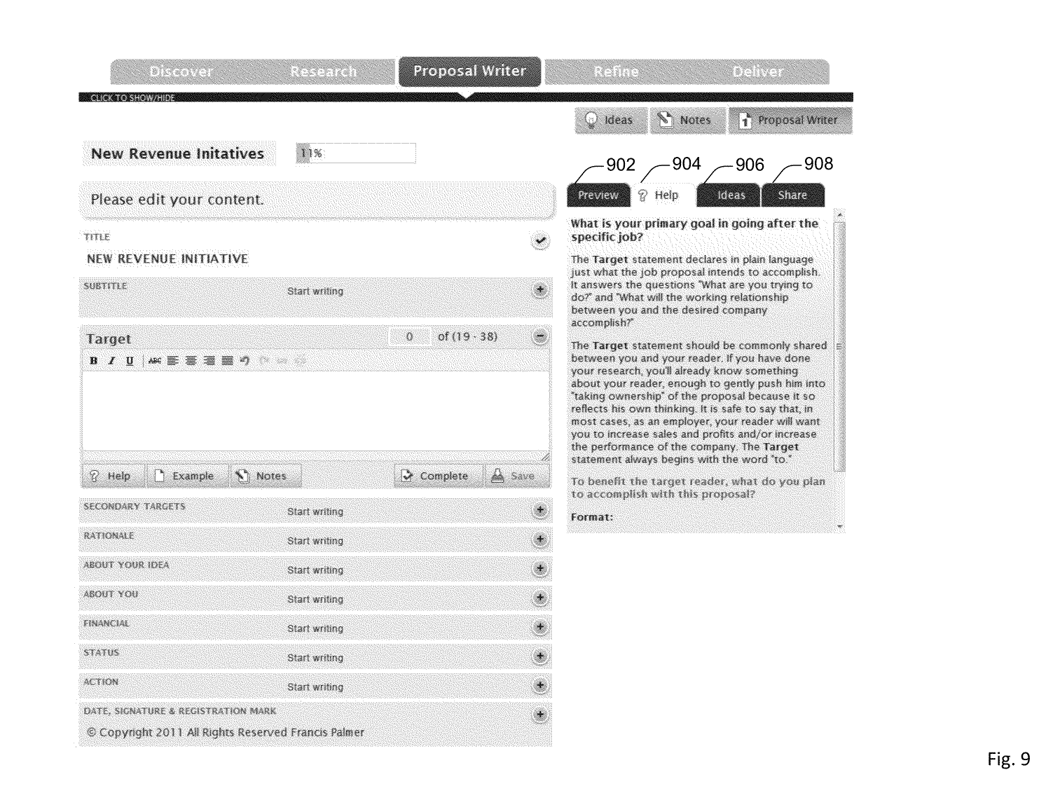

FIG. 9 shows an example of a user interface, presented in accordance with one or more embodiments. The user interface shown in FIG. 9 includes components for providing information used to generate various portions of a proposal for action. As with FIG. 8, the user interface shown in FIG. 9 may be presented in conjunction with a write stage associated with proposal generation.

The user interface shown in FIG. 9 includes various features, including some that are similar to those presented in FIG. 8. FIG. 9 includes a preview component 902, a help component 904, an ideas component 906, and a share component 908.

According to various embodiments, the preview component 902 may be used to present a visual representation of what a proposal section might look like after editing is complete. For instance, when selected, the preview component may present a portion of the proposal with formatting and other arrangement processes applied to the text.

According to various embodiments, the help component 902 selected in FIG. 9 may present information used for assisting in the identification of content for the currently selected proposal section. For instance, in FIG. 9, the help component provides suggestions regarding how to create a target statement to include in the proposal.

According to various embodiments, the share component 908 may be used to share the draft proposal with one or more other individuals. For instance, the proposal may be shared via e-mail, social networking, or some other technique. The other individuals may provide feedback such as comments regarding the content included in the proposal.

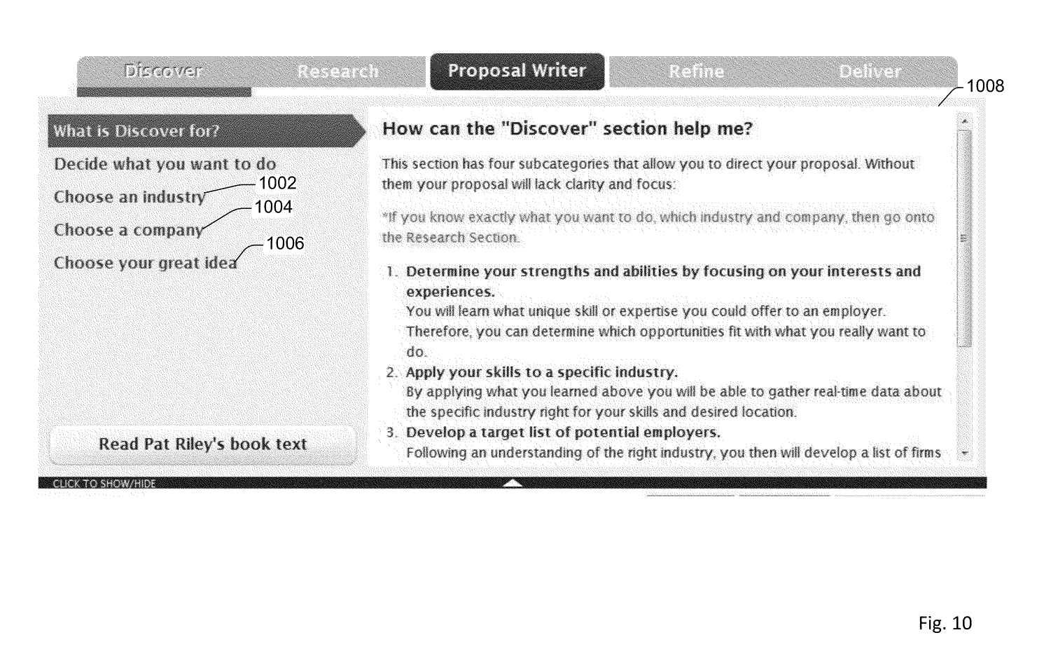

FIG. 10 shows an example of a user interface, presented in accordance with one or more embodiments. The user interface shown in FIG. 10 may be presented in conjunction with a discover stage associated with proposal generation.

According to various embodiments, the user interface shown in FIG. 10 may allow a user to select options such as to choose an industry 1002, choose a company 2004, or choose an idea 1006. When an option is selected, related information may be presented in a presentation component 1008.

According to various embodiments, the presentation component may present information for discovering answers to the selected questions. Discovering answers to the selected questions may help the user determine information to include in the proposal. For instance, the presentation component may include an interactive user interface for selecting an industry, choosing a company, or identifying an idea. As another example, the presentation component may include industry-related information such as a description of various industries in a list.

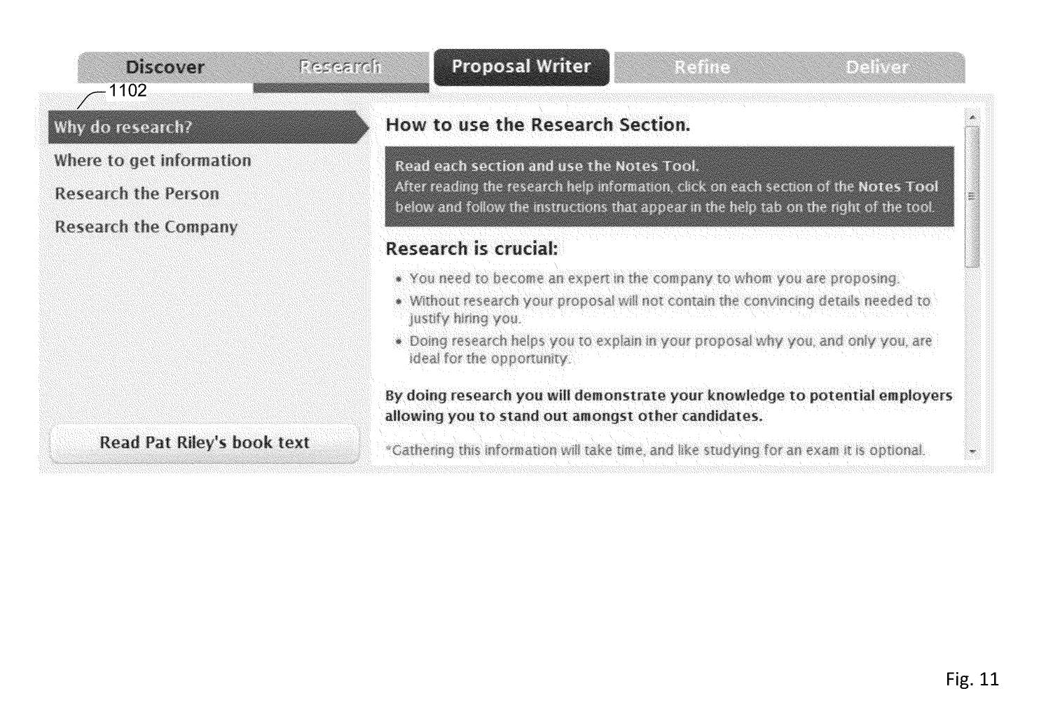

FIG. 11 shows an example of a user interface, presented in accordance with one or more embodiments. The user interface shown in FIG. 11 may be presented in conjunction with a research stage associated with proposal generation.

According to various embodiments, the user interface shown in FIG. 11 may be used to research particular topics relevant to proposal generation. The user interface shown in FIG. 11 includes a research topic selection interface 1102. When a particular research topic is selected, information and tools relevant to the research topic may be presented.

For example, when the topic “Why do research?” is presented, the user may be provided with information regarding the necessity of performing research regarding the proposal. As another example, when the topic “Research the Person” is selected, the user may be presented with tools for identifying connections at the target company via social networking data. As yet another example, when the topic “Research the Company” is selected, the user may be presented with information or tools for searching for useful information that describes the company targeted by the proposal.

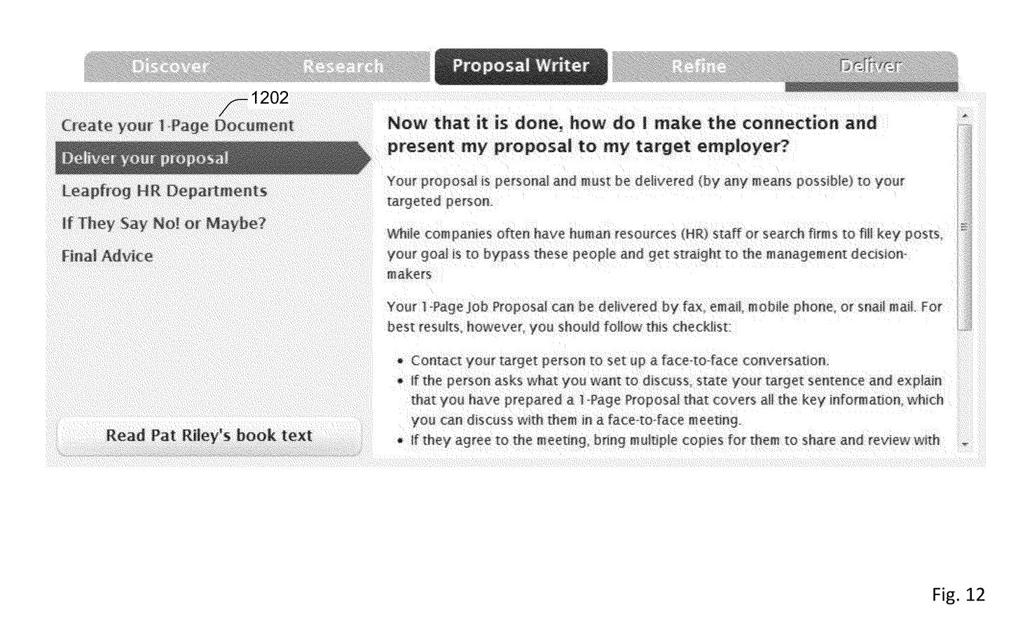

FIG. 12 shows an example of a user interface, presented in accordance with one or more embodiments. The user interface shown in FIG. 12 may be presented in conjunction with a delivery stage associated with proposal generation.

According to various embodiments, at the delivery stage of proposal generation, the user may be presented with information relevant to presenting the proposal to the proposal's target audience. The user interface component shown in FIG. 12 includes a delivery information selection interface 1202. When a topic is selected from a selection interface, information or options related to the topic may be presented.

For example, when the user requests to “Create your 1-Page Document”, the user may be presented with formatting options such as whether to create a PDF document, a Word document, a text document, or an HTML document. As another example, when the user selects the “Leapfrog HR Departments” option, the user may be presented with recommendations about how to deliver a proposal directly to a target individual within a company and bypass the conventional recipient of many resumes, a company's human resources department.

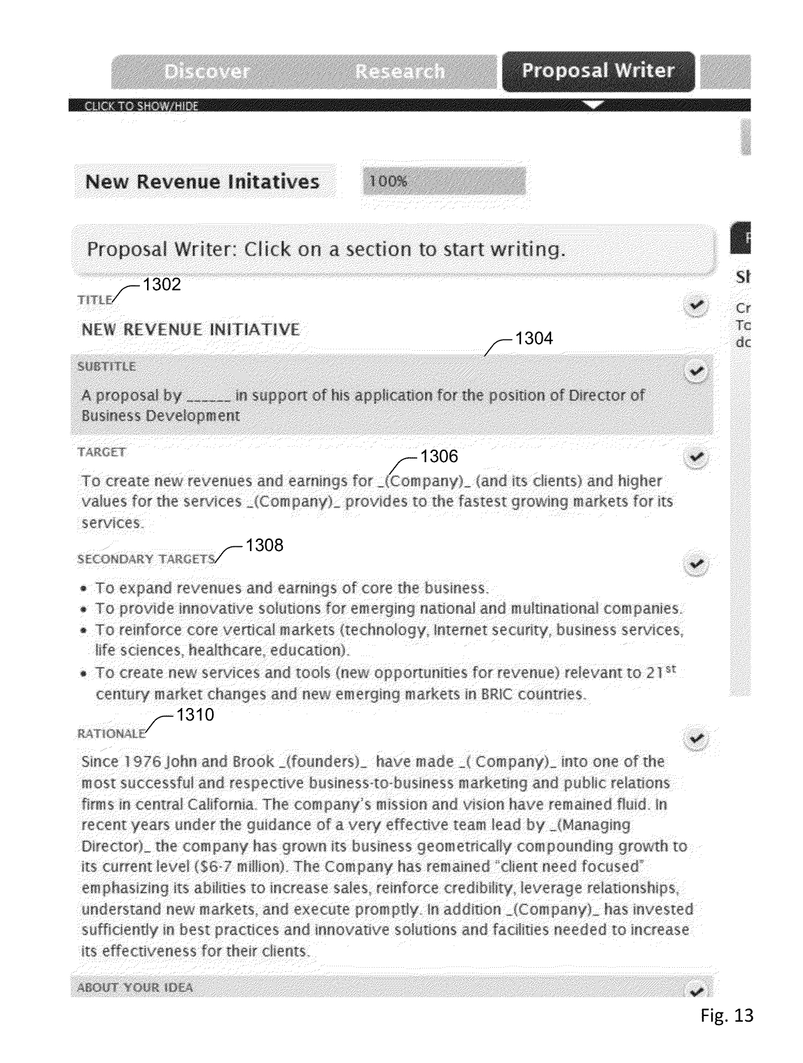

FIG. 13 shows an example of a user interface, presented in accordance with one or more embodiments. The user interface shown in FIG. 13 may be presented in conjunction with a delivery stage associated with proposal generation.

According to various embodiments, the user interface shown in FIG. 13 may be used to present a completed proposal for delivery. A proposal may include potentially many different sections, but only some of these are shown in FIG. 13. The user interface shown in FIG. 13 includes a completed title section 1302, subtitle section 1304, target section 1306, secondary target section 1308, and rationale section 1310.

According to various embodiments, text include in a proposal section may include replacement tags such as “_(Company)_”. In this way, a proposal template may be saved in such a way that it is easy to adapt the proposal to a particular user, target company, or other characteristic.

It should be noted that the above described and illustrated operations can be performed in any suitable order, and some operations may be omitted, modified, and/or customized, while additional steps may also be incorporated.

It should also be noted that the techniques described herein may be implemented in a variety of computer systems. The various techniques described herein may be implemented in hardware or software, or a combination of both. The techniques may be implemented in computer programs executing on programmable computers that each include a processor, a storage medium readable by the processor (including volatile and non-volatile memory and/or storage elements), one or more input device, and one or more output device. Program code may be applied to data entered using the input device to perform the functions described above and to generate output information. The output information may be applied to one or more output devices. Each program may be implemented in a high level procedural or object oriented programming language to communicate with a computer system. However, the programs can be implemented in assembly or machine language, if desired. In any case, the language may be a compiled or interpreted language.

A computer program may be stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

In the foregoing specification, the disclosure has been described with reference to specific embodiments. However, one of ordinary skill in the art appreciates that various modifications and changes can be made without departing from the scope of the claims below. For example, the reader is to understand that the specific ordering and combination of process actions shown in the process flow diagrams described herein is merely illustrative, and that using different or additional process actions, or a different combination or ordering of process actions can be used to implement the embodiments. Accordingly, the specification and figures are to be regarded in an illustrative rather than a restrictive sense, and all such modifications are intended to be included within the scope of invention.

1. A method comprising:
identifying input information corresponding with each of a plurality of sections to include in a proposal for action, at least a portion of the input information being received via a communications interface;
determining, at a computing device, output information to include in the proposal for action, the output information being determined based on the identified input information; and
creating a document representing the proposal for action, the created document including the output information, the created document being stored on a storage system.

2. The method recited in claim 1, wherein the created document fits on a single page, and wherein creating the document representing the proposal for action comprises organizing and formatting the output information to fit the output information on the single page.

3. The method recited in claim 1, wherein identifying input information comprises receiving answers to one or more structured questions related to the proposal for action.

4. The method recited in claim 1, wherein determining output information comprises:
identifying, based on the identified input information, one or more queries for determining the output information;
providing the one or more queries to a database system, search engine, or social network; and
processing a response received from the database system, search engine, or social network in response to the one or more queries to identify a designated portion of the output information.

5. The method recited in claim 4, wherein the designated portion of the output information identified is selected from the group consisted of: an industry related to the proposal for action, a company to which the proposal for action is directed, and an individual to which the proposal for action is directed.

6. The method recited in claim 1, the method further comprising:
transmitting, via the communications interface, a first message providing access the created document to a recipient; and
receiving, via the communications interface, a second message including feedback relating to the created document.

7. The method recited in claim 1, wherein determining the output information comprises:
providing access to an interactive research tool, the interactive research tool facilitating the identification of information related to the proposal for action based on interactive user input.

8. The method recited in claim 1, wherein the plurality of sections includes a title section, a target section, a financial section, a rationale section, a request for action section, and a status section.

9. A computing system comprising:
a communications interface operable to receive input information corresponding with each of a plurality of sections to include in a proposal for action, at least a portion of the input information being received via a communications interface;
a processor operable to determine output information to include in the proposal for action, the output information being determined based on the identified input information; and
a storage system operable to store creating a document representing the proposal for action, the created document including the output information.

10. The computing system recited in claim 9, wherein the created document fits on a single page, and wherein creating the document representing the proposal for action comprises organizing and formatting the output information to fit the output information on the single page.

11. The computing system recited in claim 9, wherein receiving the input information comprises receiving answers to one or more structured questions related to the proposal for action.

12. The computing system recited in claim 9, wherein determining output information comprises:
identifying, based on the identified input information, one or more queries for determining the output information;
providing the one or more queries to a database system, search engine, or social network; and
processing a response received from the database system, search engine, or social network in response to the one or more queries to identify a designated portion of the output information.

13. The computing system recited in claim 12, wherein the designated portion of the output information identified is selected from the group consisted of: an industry related to the proposal for action, a company to which the proposal for action is directed, and an individual to which the proposal for action is directed.

14. The computing system recited in claim 9, the method further comprising:
transmitting, via the communications interface, a first message providing access the created document to a recipient; and
receiving, via the communications interface, a second message including feedback relating to the created document.

15. The computing system recited in claim 9, wherein determining the output information comprises:
providing access to an interactive research tool, the interactive research tool facilitating the identification of information related to the proposal for action based on interactive user input.

16. The computing system recited in claim 9, wherein the plurality of sections includes a title section, a target section, a financial section, a rationale section, a request for action section, and a status section.

17. One or more computer readable media having instructions stored thereon for performing a method, the method comprising:
identifying input information corresponding with each of a plurality of sections to include in a proposal for action, at least a portion of the input information being received via a communications interface;
determining output information to include in the proposal for action, the output information being determined based on the identified input information; and
creating a document representing the proposal for action, the created document including the output information.

18. The one or more computer readable media recited in claim 17, wherein the created document fits on a single page, and wherein creating the document representing the proposal for action comprises organizing and formatting the output information to fit the output information on the single page.

18. The one or more computer readable media recited in claim 17, wherein identifying input information comprises receiving answers to one or more structured questions related to the proposal for action.

19. The one or more computer readable media recited in claim 17, wherein determining output information comprises:
identifying, based on the identified input information, one or more queries for determining the output information;
providing the one or more queries to a database system, search engine, or social network; and
processing a response received from the database system, search engine, or social network in response to the one or more queries to identify a designated portion of the output information.

20. The one or more computer readable media recited in claim 19, wherein the designated portion of the output information identified is selected from the group consisted of: an industry related to the proposal for action, a company to which the proposal for action is directed, and an individual to which the proposal for action is directed.
